(19) United States
(12) Patent Application Publication
(10) Pub. No.: US 2014/0158477 A1
(43) Pub. Date: Jun. 12, 2014

(54) FILLER PIECE FOR A MEASURING STATION FOR VEHICLE MEASUREMENT

(71) Applicant: Tobias WIRBSER, Muenchen (DE)

(72) Inventor: Tobias WIRBSER, Muenchen (DE)

(73) Assignee: ROBERT BOSCH GMBH

(21) Appl. No.: 14/102,012

(22) Filed: Dec. 10, 2013

(30) Foreign Application Priority Data
Dec. 10, 2012 (DE) 102012222607.9

(51) Int. Cl. F16D 63/00; E01D 18/00

(52) U.S. Cl. CPC F16D 63/006; E01D 18/00
USPC 188/69

(57) ABSTRACT

A filler piece for locking a turntable, which is situated in a driving surface of a measuring station for vehicle measurement, the turntable being designed to be generally circular, having at least one area projecting in the radial direction to the outside from the circumference of the turntable, the filler piece being designed in such a way that it at least partially fills a space between the driving surface and the turntable. The filler piece extends so far around the circumference of the turntable that it blocks a movement of an area projecting in the radial direction to the outside along the circumference of the turntable and thus prevents a rotational movement of the turntable.

### CROSS REFERENCE

The present application claims the benefit under 35 U.S.C. §119 of German Patent Application No. DE 10 2012 222 607.9 filed on Dec. 10, 2012, which is expressly incorporated herein by reference in its entirety.

### FIELD

The present invention relates to a filler piece for a measuring station for vehicle measurement, in particular for a measuring station which is equipped with a turntable.

### BACKGROUND INFORMATION

Measuring stations for vehicle measurement generally have turntables, which make it possible to turn the steerable wheels of a vehicle to be measured during the measuring procedure in a targeted and controlled way, in order to be able to carry out measurements even on turned wheels.

Since the turntables are generally circular, a gap is present in each case between the turntable and the adjacent driving surface. Before the wheels of the vehicle are driven onto and off of the turntables, filler pieces are inserted into the gap between the turntable and the adjacent driving surface, in order to make the transition between the driving surface and the turntable as smooth as possible and to prevent the wheels from dropping into the gap when driving onto the turntable.

To prevent an unstable condition caused by an unintended rotation of the turntables while the vehicle is being driven on and off, the turntables are additionally locked before the vehicle is driven on and off.

For locking the turntables, for example, locking pins are inserted into openings, which are formed in the turntable and a base plate lying beneath it. Before carrying out the measurements, the locking pins must be removed in order to cancel the locking and make the desired rotation of the turntable possible.

An object of the present invention is to simplify the operation of a measuring station having such turntables and, in particular, make it more time-saving.

### SUMMARY

In accordance with the present invention, a filler piece which is used to fill the gap between the driving surface and a turntable is designed in such a way that it locks the turntable and prevents the turntable from rotating when it is inserted into the gap between the driving surface and the turntable as intended.

An example filler piece according to the present invention for locking a turntable, which is situated in a driving surface of a measuring station for vehicle measurement, and which is designed to be generally circular, having at least one area projecting in the radial direction to the outside from the outer circumference of the turntable, is formed in such a way that it at least partially fills the gap between the driving surface and the turntable, and in doing so extends so far along the circumference of the turntable that it blocks a movement of at least one area of the turntable projecting in the radial direction to the outside along the circumferential direction of the turntable, and in this way prevents a rotational movement of the turntable.

The present invention also includes a combination of a turntable, which is designed to be generally circular, having at least one projection projecting in the radial direction to the outside from the circumference of the turntable, and one example filler piece according to the present invention. A combination of a turntable and an example filler piece coordinated with one another in this way makes it possible to lock the turntable in a way that is in particular effective and reliable.

An example method according to the present invention for locking a turntable, which is situated in a driving surface of a measuring station for vehicle measurement, the turntable being designed to be generally circular, having at least one area projecting in the radial direction to the outside from the circumference of the turntable, includes the step of situating at least one filler piece between the driving surface and the turntable in such a way that the filler piece at least partially fills a gap between the driving surface and the turntable, and the filler piece extends so far along the circumference of the turntable that it blocks a movement of the area of the turntable projecting in the radial direction to the outside along the circumference of the turntable, and as a result prevents the turntable from rotating.

An example method for vehicle measurement on a measuring station, which has at least one turntable and an example filler piece according to the present invention, includes:
locking the turntable using the example method according to the present invention described above;
driving a vehicle onto the measuring bay, so that at least one wheel of the vehicle is situated on a turntable;
removing the filler piece from the space between the turntable and the driving surface, so that the turntable is rotatable;
carrying out the measurements.

In one specific example embodiment, the method additionally includes locking the turntable after carrying out the measurements using the method according to the present invention and driving the wheel of the vehicle from the turntable.

In one specific embodiment, the filler piece has at least one partially circular recess which is designed for accommodating the turntable. The radius of the partial circle of the recess is larger or identical to the radius of the turntable. A filler piece designed in this manner makes it possible to fill the gap between the turntable and the driving surface in a way that is in particular effective.

In one specific embodiment, the filler piece has at least one area, which has the same thickness or height as the turntable, so that the turntable and the filler piece provide a level, in particular stepless driving surface, when the filler piece is situated in the gap between the turntable and the driving surface. A level and stepless driving surface makes it possible to place the vehicle onto the turntable particularly smoothly and in particular jerk-free.

In one specific example embodiment, the filler piece includes at least two elements which are designed in particular to be mirror symmetrical. A filler piece designed from at least two elements is in particular simple to handle, to position on the turntable and remove from it again.

In one specific embodiment, the filler piece has feet which are designed in such a way that they support and/or lock the filler piece on the floor under the turntable. Suitably designed feet make it possible for the filler piece to be situated and fixed particularly effectively and reliably in the correct position in which it fills the gap between the turntable and the driving surface and prevents the turntable from rotating.

In one specific embodiment, the filler piece is made from wood, metal and/or plastic, in particular injection molded plastic. The filler piece may be manufactured from wood in a particularly simple and cost-effective way. A particularly stable filler piece may be manufactured from metal. Plastic makes it possible to produce a particularly light but nonetheless stable filler piece. The filler piece may be manufactured in a particularly simple and cost-effective way in an injection molding process.

### BRIEF DESCRIPTION OF THE DRAWINGS

The present invention is explained in greater detail below based on the figures.

FIG. 1 shows a top view of a turntable and an example filler piece according to the present invention.

FIG. 2 shows a perspective view of an example filler piece according to the present invention.

### DETAILED DESCRIPTION OF EXAMPLE EMBODIMENTS

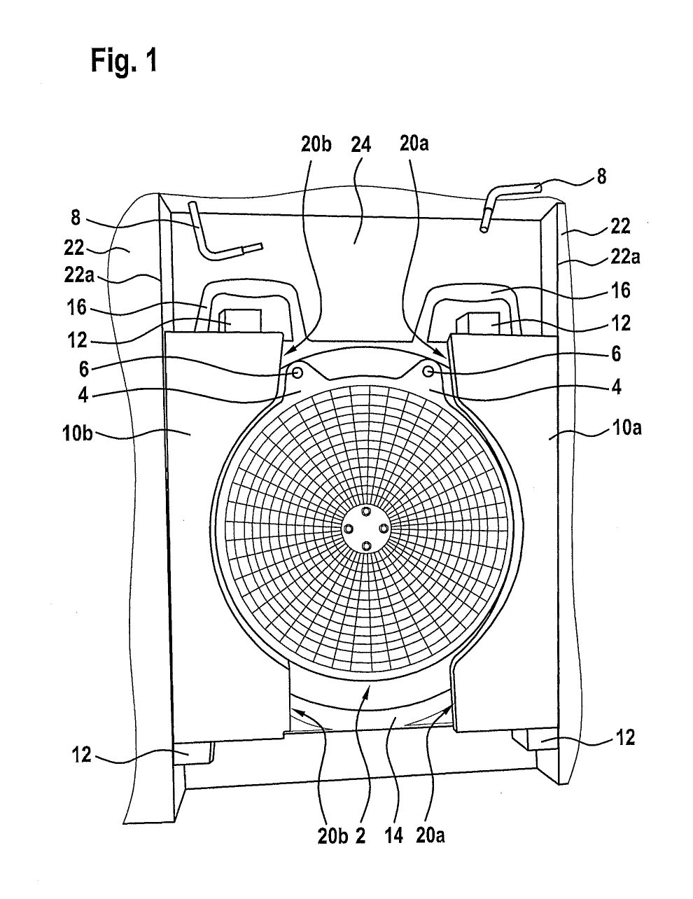

FIG. 1 shows a top view of a section of a measuring station for vehicle measurement having a turntable 2, which is locked using a filler piece 10a, 10b according to the present invention.

Turntable 2 is situated in driving surface 22 of the measuring station, it being provided that a vehicle rolls from left to right or from right to left with one of its steerable wheels onto turntable 2 and again rolls off from turntable 2 after the conclusion of the measurements.

Turntable 2 is supported movably in driving surface 22, so that it may be moved transversely to the intended direction of travel of the vehicle with the aid of handles 16, meaning from up to down in the representation in FIG. 1, in order to adjust the position of turntable 2, and in particular the distance from a second turntable 2, which is not shown in FIG. 1, to the track width of the vehicle to be measured.

In the top view, turntable 2 is generally circular in design, two areas 4 projecting in the radial direction to the outside being formed along its circumference in an area represented at the top of FIG. 1. In each of areas 4 projecting in the radial direction to the outside, an opening 6 is formed, which is oriented generally parallel to the axis of rotation of turntable 2. Pins 8 which are inserted into openings 6 and correspondingly formed openings (which are not identifiable in FIG. 1), in a base plate 14 beneath turntable 2, make it possible to lock turntable 2, in order to avoid an unintended rotation of turntable 2 while the vehicle is driven on or off.

After one wheel of the vehicle is driven onto turntable 2, pins 8 must be removed from openings 6, in order to be able to properly rotate turntable 2 during the measuring procedure and turn the wheel situated on it.

Locking and releasing turntable 2 by inserting and removing pins 8 is time-consuming and error-prone. Furthermore, there is the danger that pins 8 will be lost in the removed condition and will need to be replaced.

While the vehicle wheel is driven onto and off, a filler piece, which includes two filler elements 10a, 10b in this exemplary embodiment, is inserted into the gap between driving surface 22 and turntable 2, in order to prevent the vehicle wheel from falling into the gap when the vehicle wheel is driven onto turntable 2. After the vehicle wheel has been positioned on turntable 2, filler elements 10a, 10b are removed to make it possible to rotate turntable 2 and accordingly turn the vehicle wheel.

Filler elements 10a, 10b each extend with one side facing away from turntable 2 parallel to edge 22a of driving surface 22 and with a diametrically opposed side facing the turntable in a partially circular arc along a circumferential area of turntable 2.

Filler elements 10a, 10b according to the example embodiment of the present invention are designed in such a way that at least one locking area 20a, 20b of each extends as far as an area 4 projecting in the radial direction to the outside from the circumference of turntable 2, and in this way prevent turntable 2 from rotating if filler elements 10a, 10b, as shown in FIG. 1, are properly inserted into the gap between turntable 2 and driving surface 22.

This therefore makes it possible to omit a time-consuming and error-prone locking of turntable 2 by inserting pins 8 into openings 6. It is also possible to omit the formation of openings 6 in areas 4 projecting to the outside. A filler piece 10a, 10b according to the present invention may also, of course, be used in connection with conventional turntables 2, in which openings 6 have (still) been formed in areas 4 projecting to the outside.

Turntable 2 is “automatically” locked by inserting filler elements 10a, 10b into the gap between driving surface 22 and turntable 2 before the vehicle drives onto turntable 2. This therefore reliably prevents the locking of turntable 2 from being forgotten. This improves the operating reliability of the measuring station.

The locking is “automatically” canceled when filler elements 10a, 10b are removed in preparation for the measurements, after one wheel of the vehicle has been positioned on turntable 2.

The two work steps of inserting and removing the filler pieces and locking and releasing the turntable, which are necessary in the related art, are each combined into one work step.

In the direction of travel lateral to turntable 2 (above and beneath turntable 2 in FIG. 1), filler elements 10a, 10b have foot elements 12, which engage base plate 14, on which turntable 2 is rotatably situated, and support filler elements 10a, 10b on a floor 24 lying beneath turntable 2 and driving surface 22. Foot elements 12 are designed in such a way that filler elements 10a and 10b are situated and fixed with as little play as possible in the gap between turntable 2 and driving surface 22 and in this way lock turntable 2 reliably and with little play.

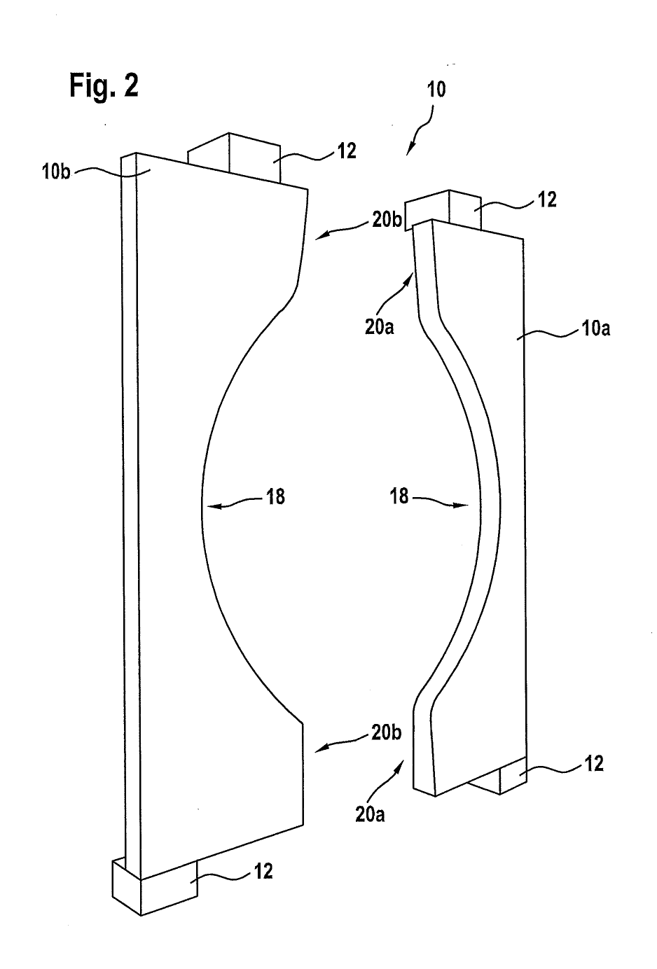

FIG. 2 shows a perspective view of two filler elements 10a, 10b, which in combination form a filler piece according to the present invention.

It is apparent that filler elements 10a, 10b are each designed to have a partially circular recess 18. Recess 18 is formed in such a way that its edge runs parallel to the outer circumference of turntable 2, when filler elements 10a, 10b are situated in the position shown in FIG. 1 between turntable 2 and adjacent driving surface 22, so that the distance between filler elements 10a, 10b and turntable 2 along the circumference of turntable 2 is constant and as small as possible.

The radius of recesses 18 is a little larger than the radius of the outer circumference of turntable 2, so that a narrow gap remains between turntable 2 and filler elements 10a, 10b, making it possible for filler elements 10a, 10b to be inserted into the gaps between turntable 2 and driving surface 22 and removed from them in a simple manner.

The height of feet 12 and the thickness of filler elements 10a, 10b are preferably designed in such a way that the surface of filler elements 10a, 10b is generally in a common plane with the surface of turntable 2 and driving surface 22, so that a generally level and in particularly stepless driving surface is created, on which one wheel of the vehicle may be driven onto and off of turntable 2 jerk-free, without it having to overcome steps and/or trenches.

Filler elements 10a, 10b may be made from wood, metal and/or a plastic, in particular as an injection molded part.

Light filler pieces or filler elements 10a, 10b, which are in particular simple to handle, may be manufactured from plastic, in particular injection molded plastic in a particularly simple and cost-effective way.

What is claimed is:

1. A filler piece for locking a turntable situated in a driving surface of a measuring station for vehicle measurement, the turntable being circular and having at least one area projecting in a radial direction to an outside from an outer circumference of the turntable, the filler piece being designed in such a way that the filler piece at least partially fills a space between the driving surface and the turntable, the filler piece being designed in such a way that the filler piece extends so far along the outer circumference of the turntable that the filler piece blocks a movement of at least one area of the turntable projecting in the radial direction to the outside in the circumferential direction of the turntable and prevents a rotational movement of the turntable.

2. The filler piece as recited in claim 1, wherein the filler piece has at least one partially circular recess for accommodating the turntable, a radius of the recess being one of larger than or the same as the radius of the turntable.

3. The filler piece as recited in claim 1, wherein the filler piece has at least one area which has the same thickness as the turntable in a direction perpendicular to the driving surface, so that the turntable and the filler piece together provide a level driving surface.

4. The filler piece as recited in claim 1, wherein the filler piece includes at least two filler elements which are mirror symmetrical to one another.

5. The filler piece as recited in claim 1, wherein the filler piece has feet which are designed at least one of to support and fix, the filler piece on a base plate situated under the turntable.

6. The filler piece as recited in claim 1, wherein the filler piece includes at least one of wood, metal, plastic, and injection molded plastic.

7. A system, comprising:
a circular turntable situated in a driving surface, the turntable having at least one area projecting in a radial direction to an outside from a circumference of the turntable; and
a filler piece for locking the turntable, the filler piece being designed in such a way that the filler piece at least partially fills a space between the driving surface and the turntable, the filler piece being designed in such a way that the filler piece extends so far along the outer circumference of the turntable that the filler piece blocks a movement of at least one area of the turntable projecting in the radial direction to the outside in the circumferential direction of the turntable and prevents a rotational movement of the turntable.

8. A method for locking a turntable which is situated in a driving surface of a measuring station for vehicle measurement, the turntable being circular and having at least one area projecting in a radial direction to the outside from a circumference of the turntable, the method comprising:
situating at least one filler piece between the driving surface and the turntable so that the filler piece at least partially fills a gap between the driving surface and the turntable, the filler piece extending so far around the circumference of the turntable that the filler piece blocks a movement of the area projecting in the radial direction to the outside along the circumference of the turntable in the radial direction and prevents the turntable from rotating.

9. A method for vehicle measurement on a measuring station which includes a turntable situated in a driving surface of the measuring station, and a filler piece for locking the turntable, the turntable being circular and having at least one area projecting in a radial direction to the outside from an outer circumference of the turntable, the filler piece being designed in such a way that the filler piece at least partially fills a space between the driving surface and the turntable, the filler piece being designed in such a way that the filler piece extends so far along the outer circumference of the turntable that the filler piece blocks a movement of at least one area of the turntable projecting in the radial direction to the outside in the circumferential direction of the turntable and prevents a rotational movement of the turntable, the method comprising:
locking the turntable by situating the filler piece between the driving surface and the turntable so that the filler piece at least partially fills a gap between the driving surfaces and the turntable and prevents the turntable from rotating;
driving a vehicle onto the measuring station, so that one wheel of the vehicle is situated on the turntable;
removing the filler piece from the space between the turntable and the driving surface so that the turntable is rotatable; and
carrying out the measurements.

10. The method for vehicle measurement as recited in claim 9, further comprising:
after the carry out step, locking the turntable including situating the filler piece between the driving surface and the turntable so that the filler piece at least partially fills a gap between the driving surfaces and the turntable and prevents the turntable from rotating; and
driving the vehicle from the measuring station.
